(19) United States
(12) Patent Application Publication
(10) Pub. No.: US 2011/0040852 A1
(43) Pub. Date: Feb. 17, 2011

(54) OBTAINING AND PROVIDING CACHED SETTINGS WITHIN A DEVELOPMENT PLATFORM

(76) Inventor: Kiran Sakhare, Bangalore (IN)

Correspondence Address: Kilpatrick Stockton LLP- Adobe Systems, Inc. 58083, Kilpatrick Stockton LLP, 1100 Peachtree Street, Atlanta, GA, 30309-4530, US

(21) Appl. No.: 12/539,055

(22) Filed: Aug. 11, 2009

(51) Int. Cl. G06F 15/16; G06F 9/44

(52) U.S. Cl. 709/219; 717/126; 709/227; 717/124

(57) ABSTRACT

A system identifies, in a development platform, a requirement where the requirement indicates that server information be accessible to the development platform regardless of an availability of at least one server. The system connects to the server. The system obtains caching settings from at least one server. The caching settings are available during development of at least one application to verify successful interaction between the application, and at least one server during operation of the application. The system provides the caching settings to the development platform. The caching settings represent current server information. The caching settings are integrated during operation of the development platform.

### CROSS REFERENCE TO RELATED APPLICATIONS

The present application claims the benefit of U.S. patent application Ser. No. 12/354,970 filed on Jan. 16, 2009, which is incorporated herein by reference.

### BACKGROUND

Initially, web sites were comprised of static HTML pages. Each web page was individually written in HTML, and uploaded to a web server (hosting the web site) for visitors to access via web browsers. The web server locates information (such as a web page) and returns that information to a web browser.

As web sites provided increasingly more information, and interactive web applications became more complex, the task of individually editing HTML pages became cumbersome. Additionally, providing the most appropriate and timely information specific to the needs of visitors (for example, an online store greeting a returning customer by name, and displaying products chosen specifically for that user) required dynamic delivery of web pages.

Dynamically delivered web pages provided the solution to these problems. Instead of static HTML pages residing on the web server, web pages were generated dynamically when visitors requested those pages. Web page content (such as products from a product catalog) was stored in databases, and retrieved during the dynamic generation of web pages. Dynamically generated web pages resolve the tedious problem of updating multiple web pages containing similar content (such as the information that remains consistent across multiple web pages). With dynamically generated web pages, that similar content could be added/deleted/modified in one place, and propagated across multiple web pages during the generation of those multiple web pages.

Today, development platforms enable developers to efficiently create dynamic web sites and web applications without needing to know the complex technologies involved.

### SUMMARY

Conventional computerized technologies for developing applications, including web applications, suffer from a variety of deficiencies. In particular, conventional technologies for developing web applications are limited in that conventional technologies associated with web application development require a user to build the web application (i.e., write the code), port the web application to a server, and then test the web application on the server. Database driven web sites need to access databases. These databases often reside on servers operating remotely from the development platform. Server access is required in all three phases of development (i.e., writing the code, porting the application, and testing the application) to verify successful performance of the web application during execution. During each of these three phases of development, a user must performs actions such as defining the database(s) the web application will access, updating the name of components used, as well as obtaining other server information. These actions must be performed correctly for each of the three phases of conventional web application development, yet some of the server information remains redundant across the three phases of development. Additionally, during conventional development of web applications, the server information may change, requiring the web developer to incorporate these new changes into the code for the web application. This requirement causes the web developer to expend additional time making sure the server information is up to date. During conventional web application development, a user may, for example, initiate a server refresh that results in a re-compiling of mappings that are used within content assist proposals. The user must wait for this refresh to complete before the user can continue developing the web application code when using conventional development techniques. Yet, this is a necessary step, or the web application may not interface properly with the server during execution, or the user may not have the most up to date mappings available within the content assist proposals.

Embodiments disclosed herein significantly overcome such deficiencies and provide a server setting caching system that includes a computer system and/or software executing a server setting caching process that identifies, in a development platform, a requirement to access server information regardless of an availability of a server or server(s). In other words, access to server information is needed during web application development whether or not the particular server is online. In operation, the server setting caching process connects to one or more servers to retrieve server information. The server setting caching process obtains the server information in the form of caching settings from one or more servers. These caching settings are available during development of a web application to facilitate creation of the web application code, and to verify successful interaction between the application, and the server(s) when the web application is executed. In other words, even if a server is offline, using the system disclosed herein, a web application developer can write and test web application code to verify that the interactions between the code and the server are working correctly, and without errors. The caching settings that the system disclosed herein provides to the development platform represent the current server information. In an example embodiment, the current server information represents the server information the last time the server information was cached. Without the availability of these caching settings, a web developer using the development platform would have to perform additional steps to access the caching settings. In some cases, the web developer might have to wait several minutes to retrieve necessary server information. With the caching settings provided as disclosed herein, the necessary server information is available to the user within the development platform. For example, when using code hinting, wizards, etc, within the development platform, this information is provided by the caching settings as explained herein. The system presented herein thus presents the user with server information more efficiently than if the user were to retrieve this information directly from the server on their own (e.g. using manual techniques). In another example embodiment, the system disclosed herein uses caching settings to build content assist proposals used during the development of web applications. The caching settings also provide the web developer with log files from the server, and database information such as database table names and fields.

In an example embodiment, the system disclosed herein obtains server settings upon start up of the development platform, when a server is running, when a server is added, when a server has been refreshed, and/or when server information is modified. The system disclosed herein caches settings and makes them available to the development platform. In another example embodiment, system disclosed herein provides a synchronization process and the caching settings are obtained via the synchronization process that obtains cached new settings, and performs a comparison between the existing caching settings and the cached new settings. If the system determines the cached new settings are different, the system updates the existing caching settings with the cached new settings. The system may invoke the synchronization process when the development platform is started up, or when the server setting caching process detects that a server is running. Upon completion of the synchronization process, if the server setting caching process determines that mapping information on the server has been modified, the server setting caching process rebuilds the content assist proposals. In another example embodiment, the server setting caching process periodically polls one or more servers and automatically updates the caching settings.

In an example embodiment, the server setting caching process obtains the caching settings using Remote Development Services (RDS) protocol. The server setting caching process authenticates a connection between the development platform and a server. If the authentication process is successful, the server setting caching process receives the caching settings.

In an example embodiment, the caching settings are received in eXtensible Markup Language (XML) format, and in a single file. In other words, the caching settings of one or more servers are compiled in a single XML file.

In an example embodiment, the caching settings are the most frequently used features within the development platform during development of the web applications. For example, caching settings may include data sources, log file names, or mapping defined on the servers.

Other embodiments disclosed herein include any type of computerized device, workstation, handheld or laptop computer, or the like configured with software and/or circuitry (e.g., a processor) to process any or all of the method operations disclosed herein. In other words, a computerized device such as a computer or a data communications device or any type of processor that is programmed or configured to operate as explained herein is considered an embodiment disclosed herein.

Other embodiments disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained as embodiments disclosed herein.

It is to be understood that the system disclosed herein may be embodied strictly as a software program, as software and hardware, or as hardware alone. The embodiments disclosed herein, may be employed in data communications devices and other computerized devices and software systems for such devices such as those manufactured by Adobe Systems Incorporated of San Jose, Calif.

### BRIEF DESCRIPTION OF THE DRAWINGS

The foregoing will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a high-level block diagram of a computer system according to one embodiment disclosed herein.

FIG. 2 shows a high-level block diagram of embodiments disclosed herein.

FIGS. 3A and 3B display the first and second parts of an XML file containing the caching settings.

FIG. 4 displays an example screen shot of a development platform.

FIG. 5 displays an example screen shot of a development platform containing a content assist proposal built from the caching settings.

FIG. 6 displays an example screen shot of a development platform displaying log files obtained from the caching settings.

FIG. 7 displays an example screen shot of a development platform displaying data source information obtained from the caching settings.

FIG. 8 displays an example screen shot of a development platform displaying database table names and fields obtained from the caching settings.

FIG. 9 illustrates a flowchart of a procedure performed by the system of FIG. 1, when the server setting caching process identifies, in a development platform, identifying a requirement indicating that server information be accessible to the development platform regardless of an availability of at least one server, according to one embodiment disclosed herein.

FIG. 10 illustrates a flowchart of a procedure performed by the system of FIG. 1, when the server setting caching process identifies requirement to access server information, according to one embodiment disclosed herein.

FIG. 11 illustrates a flowchart of a procedure performed by the system of FIG. 1, when the server setting caching process, upon successful authentication of the connection between the development platform and at least one server, receives the caching settings from the server, according to one embodiment disclosed herein.

FIG. 12 illustrates a flowchart of a procedure performed by the system of FIG. 1, when the server setting caching process obtains caching settings from at least one server, according to one embodiment disclosed herein.

FIG. 13 illustrates a flowchart of a procedure performed by the system of FIG. 1, when the server setting caching process provides the caching settings to the development platform, according to one embodiment disclosed herein.

FIG. 14 illustrates a flowchart of a procedure performed by the system of FIG. 1, when the server setting caching process synchronizes the caching settings with a new version of the caching settings to provide the current server information to the development platform, according to one embodiment disclosed herein.

### DETAILED DESCRIPTION

Embodiments disclosed herein include a computer system executing a server setting caching process that identifies, in a development platform, a requirement to access server information regardless of an availability of at least one server. In other words, access to server information is needed during web application development whether or not the particular server is online. The server setting caching process connects to one or more servers to retrieve server information. The server setting caching process obtains the server information in the form of caching settings from one or more servers. These caching settings are available during development of a web application to verify successful interaction between at least one application, and the server(s) when the web application is executed. The caching settings provided to the development platform represent the current server information. Without the availability of these caching settings, a web developer using the development platform would have to perform additional steps to access the caching settings. With the caching settings, the necessary server information is available to the user within the development platform. For example, the user may access the caching settings using code hinting, wizards, etc. The caching settings may be used to build content assist proposals used during the development of web applications. The caching settings provide the web developer with log files from the server, and database information such as database table names and fields.

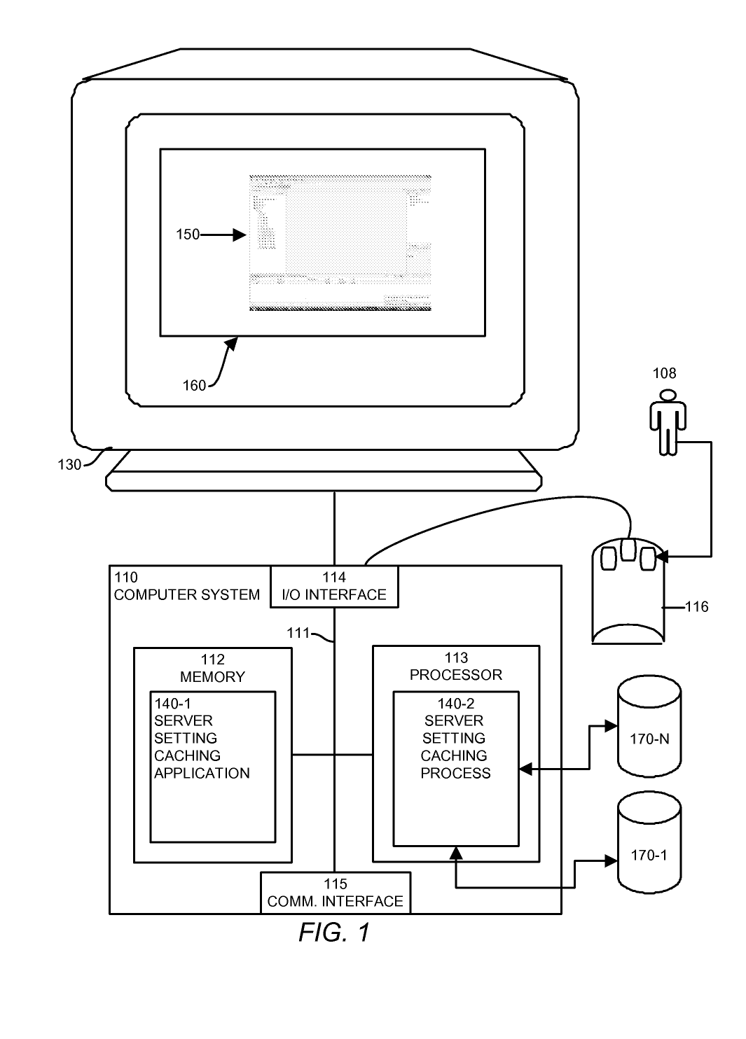

FIG. 1 is a block diagram illustrating example architecture of a computer system 110 that executes, runs, interprets, operates or otherwise performs a server setting caching application 140-1 and server setting caching process 140-2 suitable for use in explaining example configurations disclosed herein. The computer system 110 may be any type of computerized device such as a personal computer, workstation, portable computing device, console, laptop, network terminal or the like. An input device 116 (e.g., one or more user/developer controlled devices such as a keyboard, mouse, etc.) couples to processor 113 through I/O interface 114, and enables a user 108, such as a web developer, to provide input commands, and generally control the automatic graphical user interface 160 that the server setting caching application 140-1 and process 140-2 provides on the display 130. The server setting caching process 140-2 interfaces with one or more servers 170-N to obtain caching settings to provide to the development platform 150 displayed within the graphical user interface 160. As shown in this example, the computer system 110 includes an interconnection mechanism 111 such as a data bus or other circuitry that couples a memory system 112, a processor 113, an input/output interface 114, and a communications interface 115. The communications interface 115 enables the computer system 110 to communicate with other devices (i.e., other computers) on a network (not shown).

The memory system 112 is any type of computer readable medium, and in this example, is encoded with a server setting caching application 140-1 as explained herein. The server setting caching application 140-1 may be embodied as software code such as data and/or logic instructions (e.g., code stored in the memory or on another computer readable medium such as a removable disk) that supports processing functionality according to different embodiments described herein. During operation of the computer system 110, the processor 113 accesses the memory system 112 via the interconnect 111 in order to launch, run, execute, interpret or otherwise perform the logic instructions of a server setting caching application 140-1. Execution of a server setting caching application 140-1 in this manner produces processing functionality in server setting caching process 140-2. In other words, the server setting caching process 140-2 represents one or more portions or runtime instances of a server setting caching application 140-1 (or the entire a server setting caching application 140-1) performing or executing within or upon the processor 113 in the computerized device 110 at runtime.

It is noted that example configurations disclosed herein include the server setting caching application 140-1 itself (i.e., in the form of un-executed or non-performing logic instructions and/or data). The server setting caching application 140-1 may be stored on a computer readable medium (such as a floppy disk), hard disk, electronic, magnetic, optical, or other computer readable medium. A server setting caching application 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of a server setting caching application 140-1 in the processor 113 as the server setting caching process 140-2. Those skilled in the art will understand that the computer system 110 may include other processes and/or software and hardware components, such as an operating system not shown in this example.

A display 130 need not be coupled directly to computer system 110. For example, the server setting caching application 140-1 can be executed on a remotely accessible computerized device via the network interface 115. In this instance, the development platform 150 may be displayed locally to a user 108 of the remote computer, and execution of the processing herein may be client-server based.

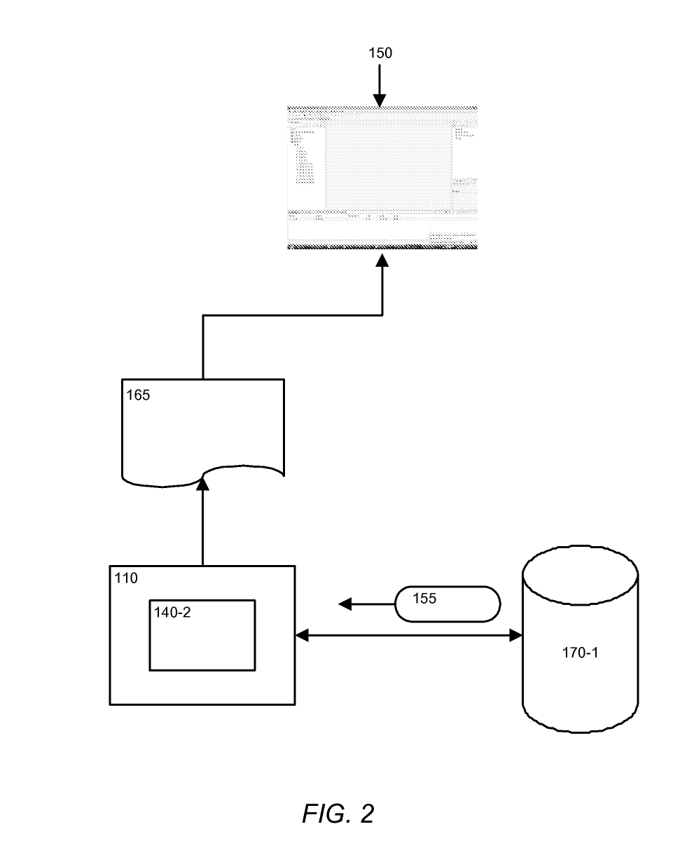

FIG. 2 is a block diagram illustrating example architecture of a computer system 110 that executes, runs, interprets, operates or otherwise performs a server setting caching process 140-2 suitable for use in explaining example configurations disclosed herein. The server setting caching process 140-2 requests server information 155 from a server 170-1. Using the server information 155, the server setting caching process 140-2 creates the caching settings 165 for use within the development platform 150. The caching settings 165 are available whether or not the server 170-1 is online.

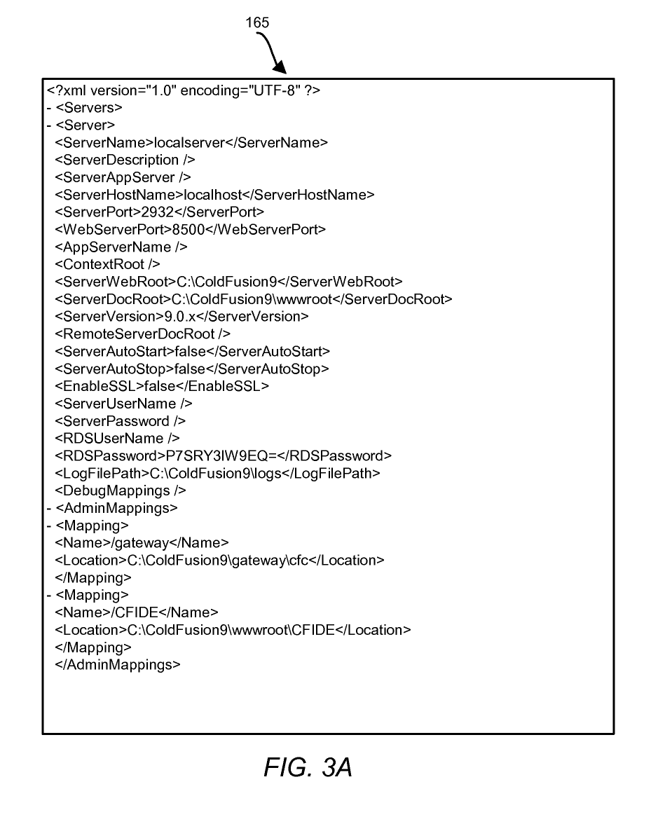

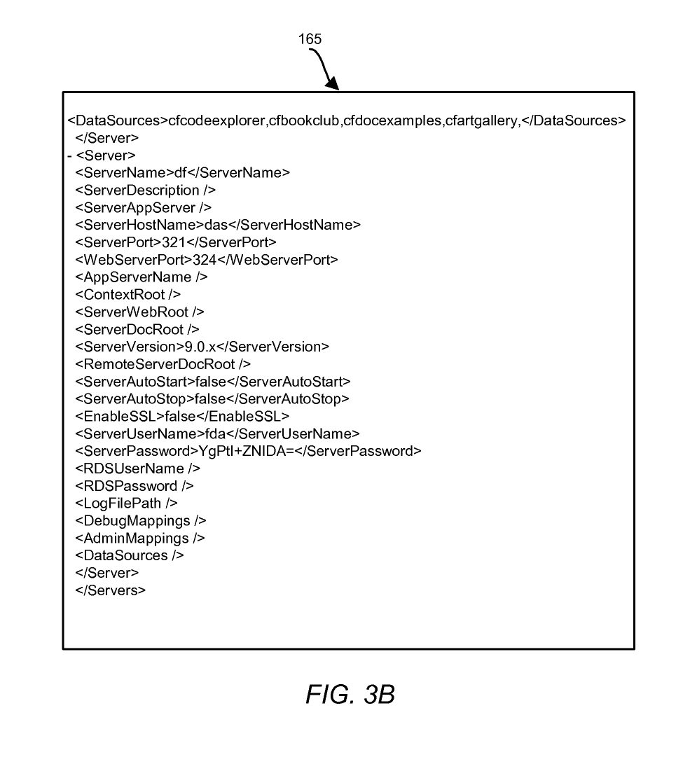

FIGS. 3A and 3B display the first and second parts of an example XML file displaying caching settings 165 from a server 170-1. These caching settings 165 are made available to a user 108 within the development platform 150. In an example embodiment, a single XML file contains the caching settings 165 from multiple servers 170-N.

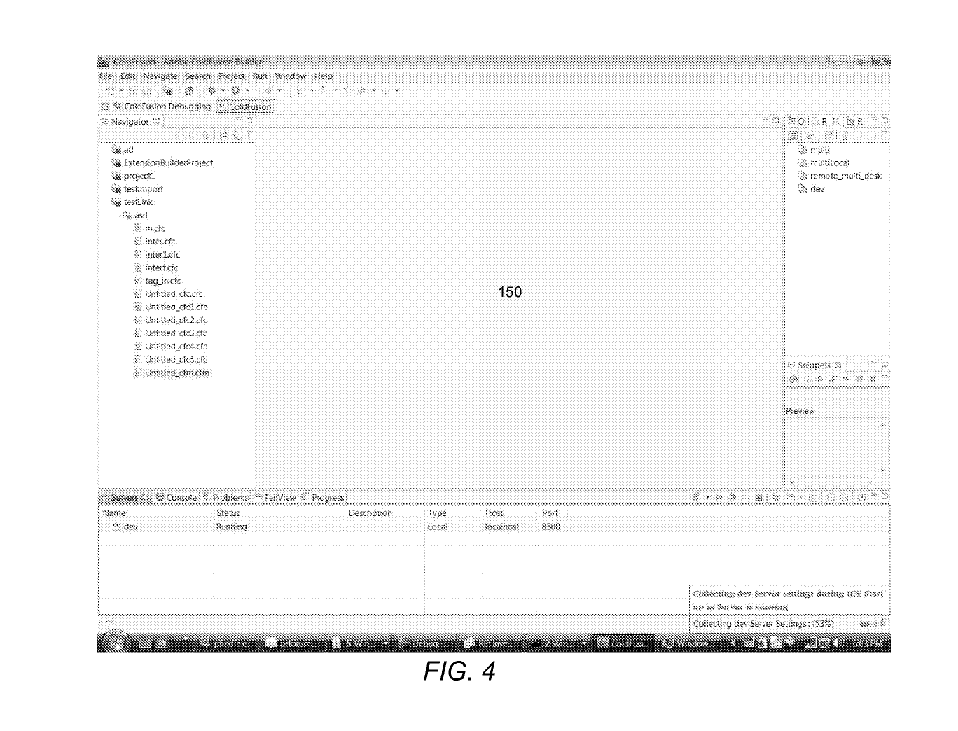

FIG. 4 is an example screenshot of a development platform 150 using caching settings 165. The server setting caching process 140-2 collects server information 155 from one or more servers 170-N, compiles the server information 155 as caching settings 165 in, for example, an XML file, and provides the caching settings 165 to a user 108 operating the development platform 150.

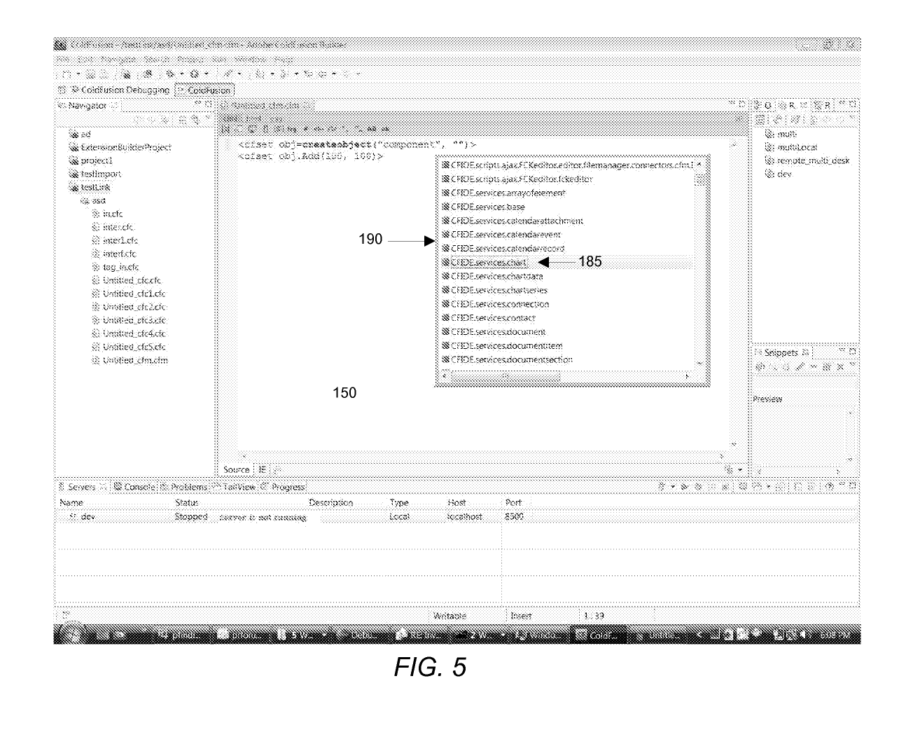

FIG. 5 is an example screenshot of a development platform 150 using caching settings 165. The server setting caching process 140-2 provides content assist proposals 190 during development of applications, such as a web application. The content assist proposal 190 displays mappings 185 created from server information 155, stored as caching settings 165. The server setting caching process 140-2 obtains the mapping information from the servers 170-N. In this example screenshot, the server 170-N is stopped.

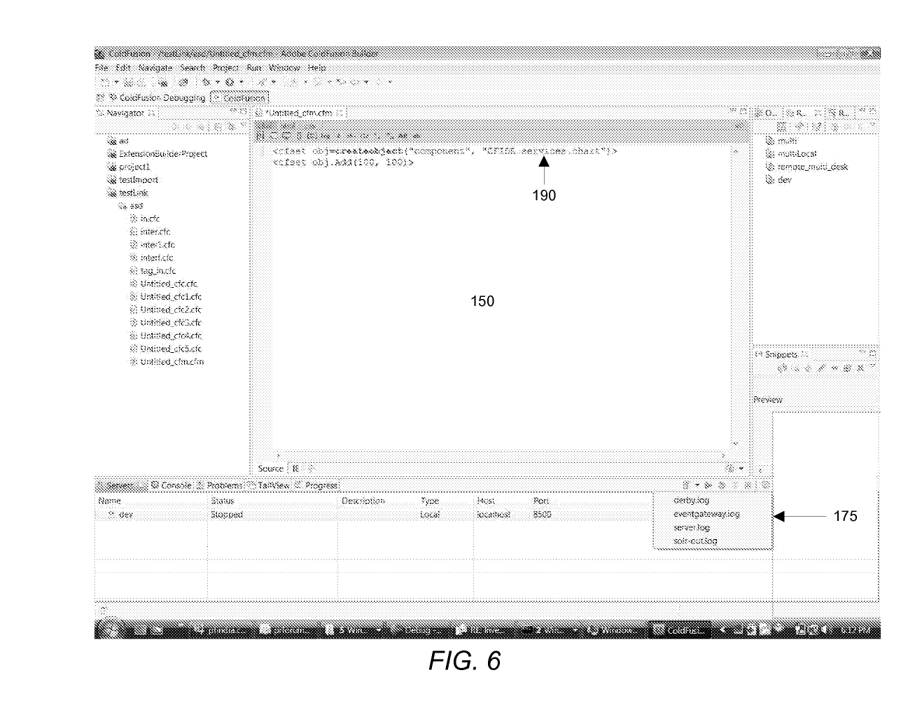

FIG. 6 is an example screenshot of a development platform 150 using caching settings 165. The server setting caching process 140-2 uses the caching settings 165 to provide code hinting for development components, such as mappings 185. The server setting caching process 140-2 also uses the caching settings 165 to provide log file 175 information to the user 108, even when the server 170-1 is offline.

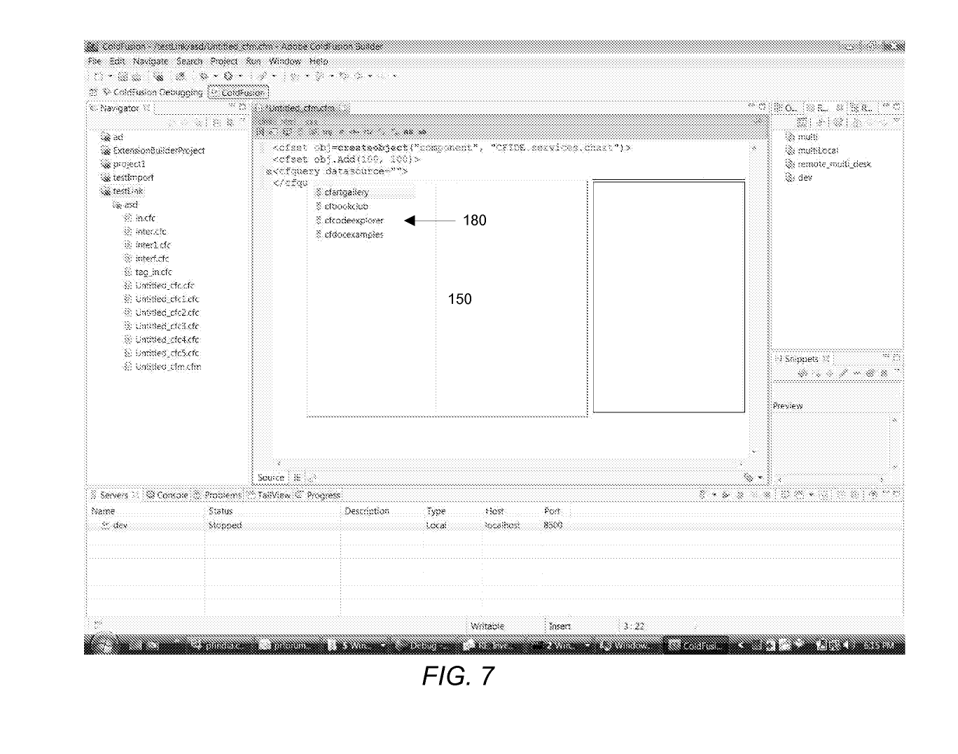

FIG. 7 is an example screenshot of a development platform 150 using caching settings 165 to list data sources 180 obtained from the server 170-1, and stored as caching settings 165. The data sources 180 (i.e., databases) are available to the user 108, operating the development platform 150, through the content assist proposal 190.

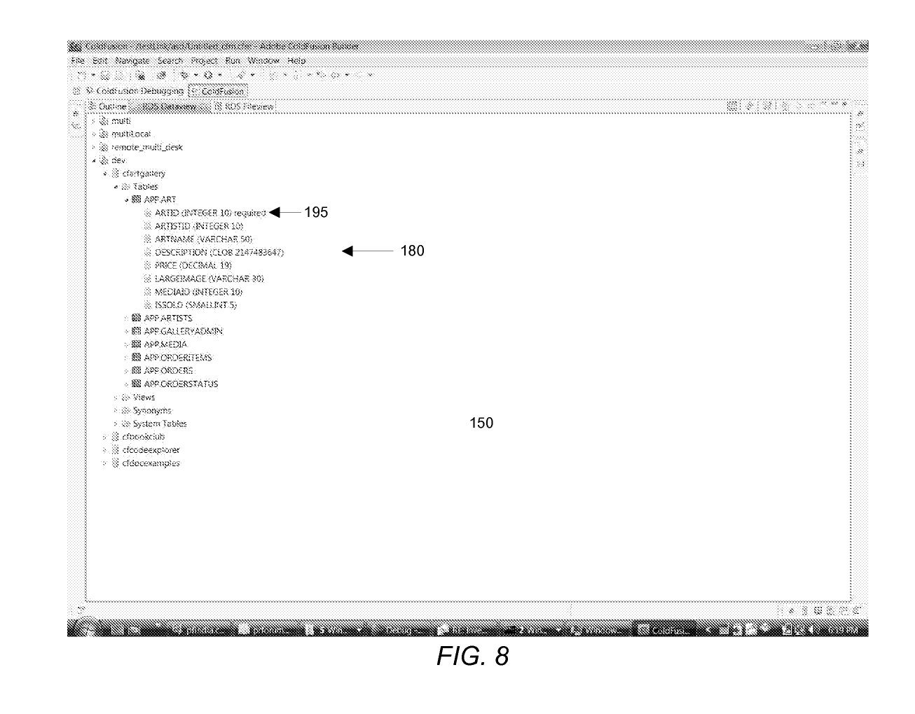

FIG. 8 is an example screenshot of a development platform 150 using caching settings 165 to list table name, and table fields associated with a data source 180. The caching settings 165 also provide foreign keys 195 associated with tables within a data source 180.

Further details of configurations explained herein will now be provided with respect to a flow chart of processing steps that show the high level operations disclosed herein to perform the server setting caching process 140-2.

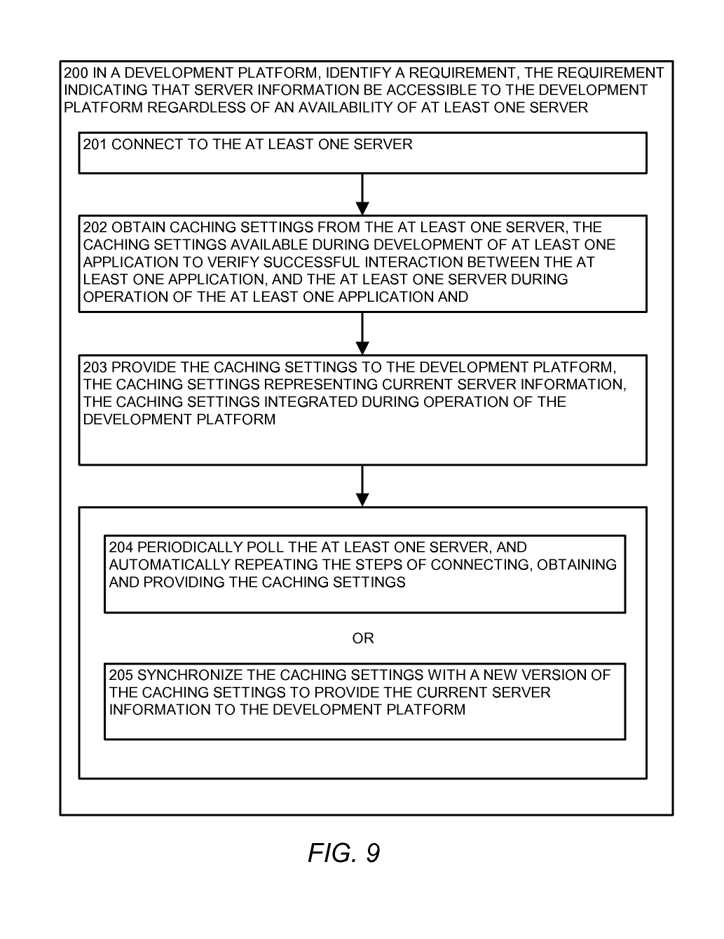

FIG. 9 is an embodiment of the steps performed by server setting caching process 140-2 when it identifies, in a development platform 150, a requirement to access server information 155 regardless of the availability of at least one server 170-N.

In step 200, the server setting caching process 140-2, identifies, in a development platform 150, a requirement to access server information 155 regardless of the availability of at least one server 170-N. The requirement indicates that server information 155 be accessible to the development platform 150 regardless of an availability of at least one server 170-N. Generally, users 108, such as web developers, create web applications that interface with servers 170-N. There are three phases to the development of web applications. First, the user 108 has to develop the web applications within a development platform 150, such as Cold Fusion. Next, the user 108 has to port the web application to a server 170-1. Finally, the user 108 has to test the web application on the server. In each of these three phases, the user 108 needs to verify that the server settings coded into the web application are correct for the web application to interface correctly with the server during execution of the web application. By incorporating the server settings into an integrated development environment, such as the development platform 150, the user 108 is spared the trial and error process of integrating the server settings with the web application. This allows the user 108 to develop web application more efficiently.

In step 201, the server setting caching process 140-2 connects to at least one server 170-N. For example, the server setting caching process 140-2 checks to see if the server 170-N is up and running. In an example embodiment, the server setting caching process 140-2 determines that the server 170-N is offline, and uses previously obtained caching settings 165.

In step 202, the server setting caching process 140-2 obtains caching settings 165 from at least one server 170-N. The caching settings 165 are available during development of at least one application to verify successful interaction between the application, and the server 170-N during operation of the application. In other words, the caching settings 165 allow the user 108 to test the web application, during development, as though the server 170-N were attached and online. Thus, when the user 108 ports the web application to the server, the correct server settings are already coded (and tested) in the web application.

In step 203, the server setting caching process 140-2 provides the caching settings 165 to the development platform 150. The caching settings 165 represent current server information 155. In an example embodiment, the caching settings 165 are integrated during operation of the development platform 150 to minimize user involvement in accessing server information 155. For example, the user 108 does not have to waste time rebuilding the workspace to obtain the mappings. Instead, the caching settings 165 contain the mappings. Within the development platform 150, these mappings may be available to the user 108, for example, via code hinting or content assist proposals 190. In another example, the user 108 does not have to navigate to the server and run an SQL query to determine table names, fields, foreign keys, etc. associated with a data source. Instead, the caching settings 165 provide this information to the user 108 within the development platform 150.

In step 204, the server setting caching process 140-2 periodically polls the server 170-N, and automatically repeats the steps of connecting, obtaining and providing the caching settings 165. In other words, the server setting caching process 140-2 runs as a background process periodically polling the server 170-N to update the caching settings 165, as necessary.

Alternatively, in step 205, the server setting caching process 140-2 synchronizes the caching settings 165 with a new version of the caching settings 165 to provide the current server information 155 to the development platform 150. In an example embodiment, the server setting caching process 140-2 obtains new caching settings 165, and compares the new caching settings 165 with the existing caching settings 165. If the server setting caching process 140-2 determines a change has occurred, the server setting caching process 140-2 will update the caching settings 165 with the new caching settings 165.

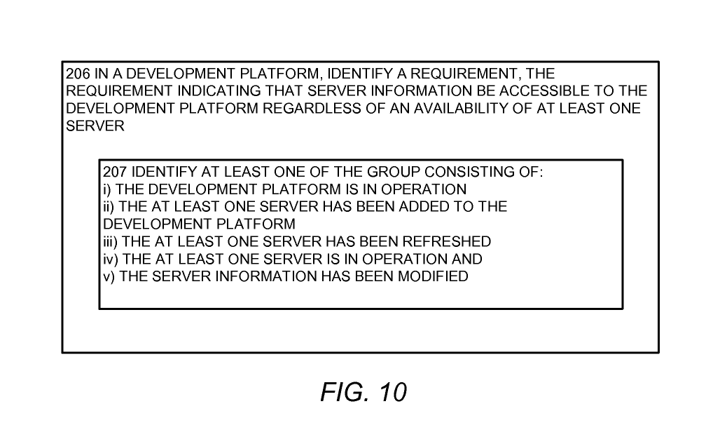

FIG. 10 is an embodiment of the steps performed by server setting caching process 140-2 when it identifies, in a development platform 150, a requirement to access server information 155 regardless of the availability of at least one server 170-N.

In step 206, the server setting caching process 140-2 identifies, in a development platform 150, a requirement to access server information 155 regardless of the availability of at least one server 170-N. The requirement indicates that server information 155 be accessible to the development platform 150 regardless of an availability of at least one server 170-N.

In step 207, the server setting caching process 140-2 identifies at least one of the group consisting of:

i) The development platform 150 is in operation. For example, the server setting caching process 140-2 determines that the development platform 150 has started up.

ii) At least one server 170-N has been added to the development platform 150. For example, the development platform 150 is up and running, and determines that a new server 170-N has been added to the development platform 150. In this scenario, the server setting caching process 140-2 invokes the process to obtain caching settings 165 from the new server 170-N. In an example embodiment, the server setting caching process 140-2 runs in the background of the development platform 150, and periodically updates the caching settings 165.

iii) At least one server 170-N has been refreshed. For example, the development platform 150 provides a menu where a user 108 can select an option to refresh the server 170-N. In the case of multiple servers 170-N, the user 108 may select specific servers 170-N to be refreshed. Upon receiving this request, the server setting caching process 140-2 obtains caching settings 165 from the selected server(s) 170-N.

iv) At least one server 170-N is in operation. For example, the server setting caching process 140-2 determines that a server 170-N is up and running. The server setting caching process 140-2 begins the process to obtain caching settings 165 from that server 170-N.

v) The server information 155 has been modified. For example, the server setting caching process 140-2 determines that the server information 155 has been modified (such as mapping information has changed). The server setting caching process 140-2 obtains new caching settings 165 to provide the development platform 150 with the most current caching settings 165.

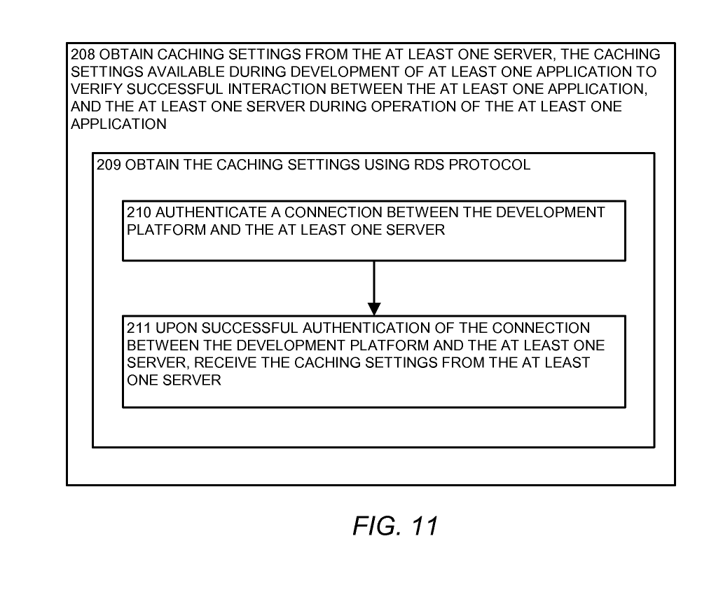

FIG. 11 is an embodiment of the steps performed by server setting caching process 140-2 when it obtains caching settings 165 from at least one server 170-N.

In step 208, the server setting caching process 140-2 obtains caching settings 165 from at least one server 170-N. The caching settings 165 are available during development of at least one application to verify successful interaction between the application, and the server 170-N during operation of the application. The caching settings 165 are available to the development platform 150 whether or not the server 170-N is online.

In step 209, the server setting caching process 140-2 obtains the caching settings 165 using Remote Development Services (RDS) protocol. RDS is a mechanism, for accessing resources, for example, on a ColdFusion server from within the development platform 150. RDS is an HTTP-based communication between the development platform 150 and the server 170-N to facilitate development of web applications. RDS allows the code within the development platform 150 to communicate with a remote server 170-N, although RDS also works if the server is located on the same computer system operating the development platform 150. RDS also works with Dream Weaver, a software package that facilitates web development.

In step 210, the server setting caching process 140-2 authenticates a connection between the development platform 150 and at least one server 170-N. In an example embodiment, the authentication process uses an identifier associated with the user 108 operating the development platform 150 to determine whether the user 108 has permission to connect to the server 170-N. If the authentication fails, the authentication process stops, and the server setting caching process 140-2 uses the existing caching settings 165, if they exist, and are available to the development platform 150.

In step 211, upon successful authentication of the connection between the development platform 150 and at least one server 170-N, the server setting caching process 140-2 receives the caching settings 165 from the server 170-N. In other words, if the authentication process succeeds, the server setting caching process 140-2 obtains the caching settings 165 from the server 170-N.

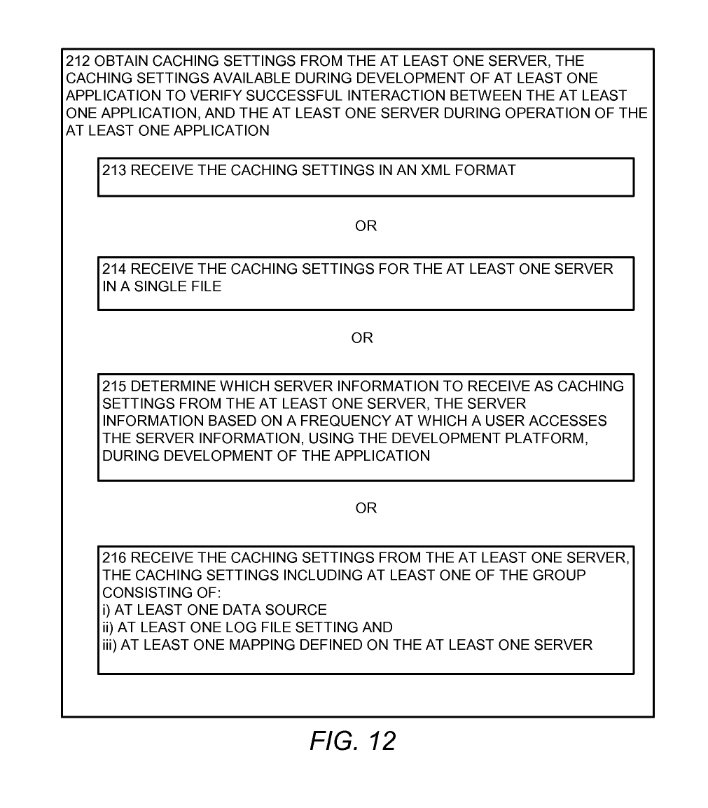

FIG. 12 is an embodiment of the steps performed by server setting caching process 140-2 when it obtains caching settings 165 from at least one server 170-N.

In step 212, the server setting caching process 140-2 obtains caching settings 165 from at least one server 170-N. The caching settings 165 are available during development of at least one application to verify successful interaction between the application, and the server 170-N during operation of the application. The caching settings 165 are available to the user 108 operating the development platform 150 whether or not the server 170-N is online. The caching settings 165 allow the user 108 to code and test the web application's connectivity to the server 170-N. This saves time during the phases of porting the web application to the server, and testing the web application on the server.

In step 213, the server setting caching process 140-2 receives the caching settings 165 in an XML format. In an example embodiment, the server setting caching process 140-2 receives the caching settings 165 from the server 170-N, for example, in an XML format, as shown in FIGS. 3A and 3B.

Alternatively, in step 214, the server setting caching process 140-2 receives the caching settings 165 for at least one server 170-N in a single file. In an example embodiment, the server setting caching process 140-2 receives the caching settings 165 from multiple servers 170-N in a single file, meaning one file exists regardless of the number of servers 170-N providing server information 155 to the caching settings 165.

Alternatively, in step 215, the server setting caching process 140-2 determines which server information 155 to receive as caching settings 165 from at least one server 170-N. The server information 155 is based on a frequency at which a user 108 accesses the server information 155, using the development platform 150, during development of the application. In other words, the server information 155 collected from the servers 170-N is based on those features used most frequently by users 108 during the development of web application. By providing the most frequently used features, without requiring the user 108 to waste time to collect or compile the server information 155, the server setting caching process 140-2 increases the user's 108 productivity.

Alternatively, in step 216, the server setting caching process 140-2 receives the caching settings 165 from at least one server 170-N. The caching settings 165 include at least one of the group consisting of:

i) At least one data source, for example, a database residing on the server 170-N. In an example embodiment, the caching settings 165 also include table names, table field and foreign key information associated with databases residing on the server 170-N. In another example embodiment, as displayed in FIG. 7, a user 108 is coding a web application. The user 108 has created a script file to query a database. The web application code queries the database using a <cfquery> tag. Within the development platform 150, when the user types <cfquery datasources=″″>, the content assist proposal 190 presents a menu listing the available data sources on the server 170-N. The user 108 selects the appropriate data source from the content assist proposal 190. These data sources are provided to the development platform 150, via the caching settings 165 whether or not the server 170-N is online.

ii) At least one log file setting, for example, the names of log files 175 residing on the server 170-N. In an example embodiment, log files 175 contain exceptions that occur during the execution of web application while interfacing with data sources. When web applications execute, log files 175 are created. These log files 175 may contain valuable information, including information helpful while debugging web applications. The log files 175 reside in a directory located on the server 170-N. While collecting server information 155, the server setting caching process 140-2 also obtains the log file information. Thus, as displayed in FIG. 6, when a user 108 is operating the development platform 150, these log files 175 are available to the user 108 via the caching settings 165.

iii) At least one mapping defined on at least one server 170-N where, for example, the mappings 185 serve as locators for various scripts and components used by the user 108 during development of web applications. With large web applications, components may reside in many different directories, and may be hard to find. Development platforms 150 provide utilities to compile these mappings 185, for example, when a user 108 invokes the content assist proposal 190. However, a user 108 must wait for this action to be completed before the user 108 can access these mappings 185. This action may take several minutes to complete. Instead, the server setting caching process 140-2 obtains the mapping 185 information from the servers 170-N, and stores them in the caching settings 165. When a user 108 requires mappings 185 from the development platform 150, the caching settings 165 provide the mappings 185 through a content assist proposal 190 as displayed in FIG. 5. Therefore, the user 108 does not have to wait for the mappings 185 to be built, and this increases the user's 108 productivity.

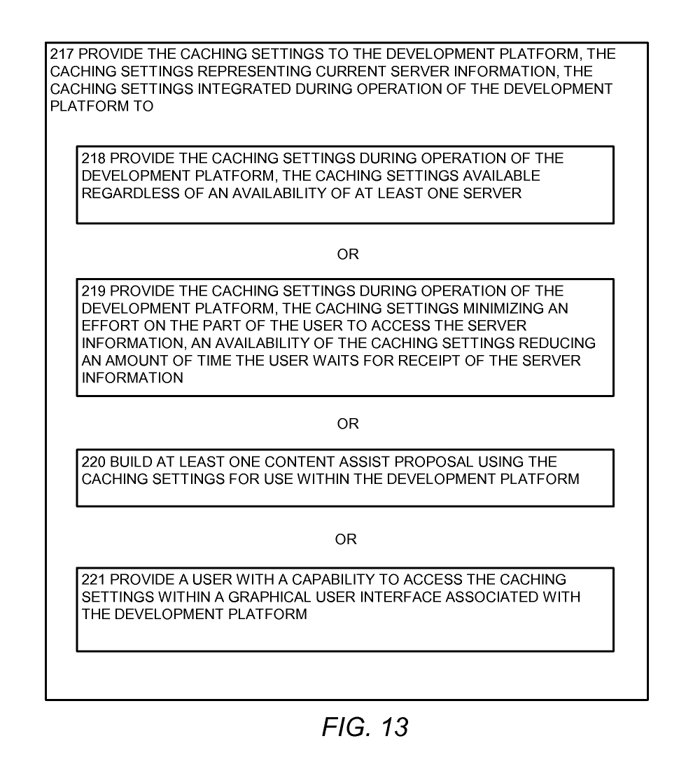

FIG. 13 is an embodiment of the steps performed by server setting caching process 140-2 when it provides the caching settings 165 to the development platform 150.

In step 217, the server setting caching process 140-2 provides the caching settings 165 to the development platform 150, where the caching settings 165 represents current server information 155. The caching settings 165 are integrated during operation of the development platform 150. In an example embodiment, the integration of the caching settings 165 minimizes user involvement to access server information 155. In other words, the server information 155 is available to the user 108 when the user 108 is developing web applications without the user 108 wasting the time to obtain and compile the server information 155. For example, the server information 155 is available to the user 108 via the content assist proposal 190 on the development platform 150.

In step 218, the server setting caching process 140-2 provides the caching settings 165 during operation of the development platform 150. The caching settings 165 are available regardless of the availability of a server 170-N. In an example embodiment, the development platform 150 relies on the caching settings 165 for the server information 155 even if the servers 170-N are online. In another example embodiment, if the servers 170-N are online, the development platform 150 still uses the caching settings 165, but the server setting caching process 140-2 communicates with the servers 170-N to determine if updated server information 155 is available. If it is, the server setting caching process 140-2 obtains the updated server information 155 in the form of caching settings 165.

Alternatively, in step 219, the server setting caching process 140-2 provides the caching settings 165 during operation of the development platform 150. In an example embodiment, the caching settings 165 minimize an effort on the part of the user 108 to access the server information 155, where the availability of the caching settings 165 reduces the amount of time the user 108 waits for the server information 155. In other words, the availability of the caching settings 165 minimizes the amount of work a user 108 has to perform to obtain the server information 155 contained within the caching settings 165. Additionally, the availability of the caching settings 165 minimizes the amount of time the user 108 wastes waiting for the development platform 150 to compile the server information 155.

Alternatively, in step 220, the server setting caching process 140-2 builds at least one content assist proposal 190, using the caching settings 165, for use within the development platform 150. FIG. 5 displays a development platform 150 where a user 108 is creating a component object within the web application code. The content assist proposal 190 provides a menu of available component options from which the user 108 may choose the correct component. The mappings 185 displayed within the content assist proposal 190 are provided by the caching settings 165. The server setting caching process 140-2 obtained these mappings 185 from the servers 170-N.

Alternatively, in step 221, the server setting caching process 140-2 provides a user 108 with a capability to access the caching settings 165 within a graphical user interface 160 associated with the development platform 150. In an example embodiment, the user 108 can access the caching settings 165 via the development platform 150 using features including, but not limited to code hinting, wizards, component name resolution, content assist proposals 190, etc.

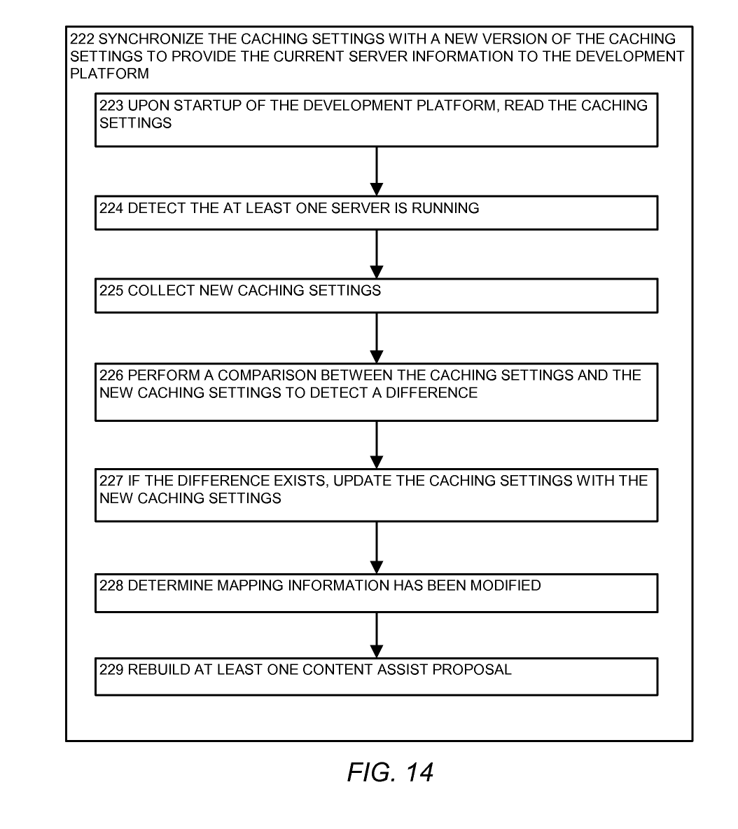

FIG. 14 is an embodiment of the steps performed by server setting caching process 140-2 when it synchronizes the caching settings 165 with a new version of the caching settings 165 to provide the current server information 155 to the development platform 150.

In step 222, the server setting caching process 140-2 synchronizes the caching settings 165 with a new version of the caching settings 165 to provide the current server information 155 to the development platform 150. In an example embodiment, the server setting caching process 140-2 synchronizes the caching settings 165 to provide the development platform 150 with the most current version of the server information 155.

In step 223, upon startup of the development platform 150, the server setting caching process 140-2 reads the caching settings 165. In an example embodiment, the server setting caching process 140-2 reads the current version of the caching settings 165 that reside on the development platform 150. In another example embodiment, if no caching settings 165 are found on the development platform 150, the server setting caching process 140-2 begins the process of obtaining server information 155 from any servers 170-N that are up and running.

In step 224, the server setting caching process 140-2 detects at least one server 170-N is up and running. Upon start up of the development platform 150, the server setting caching process 140-2 reads the current version of the caching settings 165, and then determines if any of the servers 170-N are up and running.

In step 225, the server setting caching process 140-2 collects new caching settings 165. The server setting caching process 140-2 communicates with any running servers 170-N to obtain new caching settings 165.

In step 226, the server setting caching process 140-2 performs a comparison between the caching settings 165 and the new caching settings 165 to detect a difference. In an example embodiment, the server setting caching process 140-2 performs a comparison on each of the entries within the caching settings 165 to determines if any of the server information 155 has changed since the current caching settings 165 were obtained.

In step 227, the server setting caching process 140-2 updates the caching settings 165 with the new caching settings 165 if a difference exists between the current caching settings 165 and the new caching settings 165.

In step 228, the server setting caching process 140-2 determines mapping information has been modified. In an example embodiment, the server setting caching process 140-2 determines that the mappings 185 on one of the running servers 170-N has changed.

In step 229, the server setting caching process 140-2 rebuilds a content assist proposal 190. In an example embodiment, based on the determination that the mappings 185 have changed since the time the current caching settings 165 were obtained, the server setting caching process 140-2 obtains a new caching settings 165 and rebuilds the workspace to provide the development platform 150 with the content assist proposal 190 containing the most current mappings 185.

While computer systems and methods have been particularly shown and described above with references to configurations thereof, it will be understood by those skilled in the art that various changes in form and details may be made therein without departing from the scope disclosed herein. Accordingly, the information disclosed herein is not intended to be limited by the example configurations provided above.

What is claimed is:

1. A computer readable medium having computer readable code thereon, the medium comprising instructions for:
in a development platform, identifying a requirement, the requirement indicating that server information be accessible to the development platform regardless of an availability of at least one server;
connecting to the at least one server;
obtaining caching settings from the at least one server, the caching settings available during development of at least one application to verify successful interaction between the at least one application, and the at least one server during operation of the at least one application; and
providing the caching settings to the development platform, the caching settings representing current server information, the caching settings integrated during operation of the development platform.

2. The computer readable medium of claim 1 comprising:
periodically polling the at least one server, and automatically repeating the steps of connecting, obtaining and providing the caching settings.

3. The computer readable medium of claim 1 comprising:
synchronizing the caching settings with a new version of the caching settings to provide the current server information to the development platform.

4. The computer readable medium of claim 1 wherein identifying a requirement, the requirement indicating that server information be accessible to the development platform regardless of an availability of at least one server comprises:
identifying at least one of the group consisting of:
i) the development platform is in operation;
ii) the at least one server has been added to the development platform;
iii) the at least one server has been refreshed;
iv) the at least one server is in operation; and
v) the server information has been modified.

5. The computer readable medium of claim 1 wherein obtaining caching settings from the at least one server comprises:
obtaining the caching settings using Remote Development Services (RDS) protocol.

6. The computer readable medium of claim 5 wherein obtaining the caching settings using RDS protocol comprises:
authenticating a connection between the development platform and the at least one server.

7. The computer readable medium of claim 6 comprising:
upon successful authentication of the connection between the development platform and the at least one server, receiving the caching settings from the at least one server.

8. The computer readable medium of claim 1 wherein obtaining caching settings from the at least one server comprises:
receiving the caching settings in an extensible Markup Language (XML) format.

9. The computer readable medium of claim 1 wherein obtaining caching settings from the at least one server comprises:
receiving the caching settings for the at least one server in a single file.

10. The computer readable medium of claim 1 wherein obtaining caching settings from the at least one server comprises:
determining which server information to receive as caching settings from the at least one server, the server information based on a frequency at which a user accesses the server information, using the development platform, during development of the application.

11. The computer readable medium of claim 1 wherein obtaining caching settings from the at least one server comprises:
receiving the caching settings from the at least one server, the caching settings including at least one of the group consisting of:
i) at least one data source;
ii) at least one log file setting; and
iii) at least one mapping defined on the at least one server.

12. The computer readable medium of claim 1 wherein providing the caching settings to the development platform comprises:
providing the caching settings during operation of the development platform, the caching settings available regardless of an availability of at least one server.

13. The computer readable medium of claim 1 wherein providing the caching settings to the development platform comprises:
providing the caching settings during operation of the development platform, the caching settings minimizing an effort on the part of the user to access the server information, an availability of the caching settings reducing an amount of time the user waits for receipt of the server information.

14. The computer readable medium of claim 1 wherein providing the caching settings to the development platform comprises:
building at least one content assist proposal using the caching settings for use within the development platform.

15. The computer readable medium of claim 1 wherein providing the caching settings to the development platform comprises:
providing a user with a capability to access the caching settings within a graphical user interface associated with the development platform.

16. The computer readable medium of claim 3 wherein synchronizing the caching settings with a new version of the caching settings to provide the current server information to the development platform comprises:
upon startup of the development platform, reading the caching settings;
detecting the at least one server is running;
collecting new caching settings;
performing a comparison between the caching settings and the new caching settings to detect a difference; and
if the difference exists, updating the caching settings with the new caching settings.

17. The computer readable medium of claim 16 comprising:
determining mapping information has been modified; and
rebuilding at least one content assist proposal.

18. In a computer system, a method comprising:
in a development platform, identifying a requirement, the requirement indicating that server information be accessible to the development platform regardless of an availability of at least one server;
connecting to the at least one server;
obtaining caching settings from the at least one server, the caching settings available during development of at least one application to verify successful interaction between the at least one application, and the at least one server during operation of the at least one application; and
providing the caching settings to the development platform, the caching settings representing current server information, the caching settings integrated during operation of the development platform.

19. The method of claim 18 wherein providing the caching settings to the development platform comprises:
providing the caching settings during operation of the development platform, the caching settings minimizing an effort on the part of the user to access the server information, an availability of the caching settings reducing an amount of time the user waits for receipt of the server information.

20. A computerized device comprising:
a memory;
a processor;
a communications interface;
an interconnection mechanism coupling the memory, the processor and the
communications interface;
wherein the memory is encoded with a server setting caching application that when executed on the processor is capable of caching server settings on the computerized device by performing the operations of:
in a development platform, identifying a requirement, the requirement indicating that server information be accessible to the development platform regardless of an availability of at least one server;
connecting to the at least one server;
obtaining caching settings from the at least one server, the caching settings available during development of at least one application to verify successful interaction between the at least one application, and the at least one server during operation of the at least one application; and
providing the caching settings to the development platform, the caching settings representing current server information, the caching settings integrated during operation of the development platform.
